(19) United States
(12) Patent Application Publication
(10) Pub. No.: US 2009/0313428 A1
(43) Pub. Date: Dec. 17, 2009

(54) Optimising Remote Mirroring Resynchronisation

(75) Inventor: Andries De Jong, Leiden (NL)

Correspondence Address: THE WEBB LAW FIRM, P.C., 700 KOPPERS BUILDING, 436 SEVENTH AVENUE, PITTSBURGH, PA, 15219, US

(73) Assignee: INTELLIMAGIC, Leiden (NL)

(21) Appl. No.: 12/307,982

(22) PCT Filed: Sep. 25, 2006
(86) PCT No.: PCT/NL06/50234

§ 371 Date: Jan. 8, 2009

(51) Int. Cl. G06F 12/00; G06F 12/16

(52) U.S. Cl. 711/114; 711/162; 711/E12.001; 711/E12.103

(57) ABSTRACT

The invention relates to data resynchronization on a computer system arranged to store a plurality of primary logical volumes and a plurality of associated secondary logical volumes. The method comprises executing at least one copy thread and at least one resynchronization thread in parallel, the copy thread being arranged to copy one of the secondary logical volumes to an associated tertiary logical volume at a time. The resynchronization thread is arranged to resynchronize the secondary logical volume to an associated primary logical volume, wherein the secondary logical volume is resynchronized after completion of copying the one of the secondary logical volumes. By coordinating the degree of parallelism in resynchronization with the degree in parallelism in executing the copying to a tertiary image, resynchronization is made more efficient.

### TECHNICAL FIELD

The present invention relates to computer systems and more particularly to remote mirroring of data images on such systems.

### STATE OF THE ART

In computer systems that comprise externally attached disk subsystems, very often a data image on a so-called primary disk subsystem (PDSS) is mirrored onto a data image on a remote secondary disk subsystem (SDSS). One data image may constitute one or more logical volumes. There are synchronous and asynchronous data mirroring technologies.

With synchronous data mirroring, a write from a computer to the PDSS is not finished until it is committed to the PDSS and the SDSS. IBM offers Metro Mirror™, also known as Peer-to-Peer Remote Copy (PPRC). Hitachi Data Systems (HDS) and Hewlett Packard (HP) offer TrueCopy/Synchronous. EMC offers Symmetrix Remote Data Facility (SRDF)/Synchronous (SRDF/S).

With asynchronous data mirroring, a write is finished when it is committed to the PDSS and the replication of the update is done at a later point in time. IBM offers Global Mirror™ and Global Mirror for zSeries, also known as Extended Remote Copy (XRC). HDS and HP offer TrueCopy/Asynchronous, Universal Replicator for TagmaStore and Global Mirror for zSeries, also known as Extended Remote Copy (XRC). EMC offers SRDF/Asynchronous (SRDF/A) and Global Mirror for zSeries, also known as Extended Remote Copy (XRC).

The descriptions in this document mostly use terminology that reflects IBM implementations, but are nevertheless fully applicable to the synchronous and asynchronous data mirroring implementations of the other vendors.

Occasionally a remote mirroring session gets suspended. When that happens, the problem that caused the suspension must be found and fixed. Next, the secondary data image can be resynchronised with the primary data image and the mirroring session can be re-established. When secondary volumes on the SDSS are being resynchronised with their matching primary volumes, the order in which data is transmitted to the secondary volumes does not respect the order in which the data was originally committed to the primary device. Therefore the secondary device is in an unpredictable state for as long as it is being resynchronised and disaster-fallback capabilities do not exist while resynchronisation takes place.

To overcome this issue, nowadays many installations that mirror their data, take an image copy of their secondary volumes before they initiate resynchronisation to render a tertiary data image, such that a consistent remote data image is preserved during resynchronisation. The tertiary data image is normally also stored on the SDSS and is usually taken employing a disk subsystem feature specially designed for this purpose such as FlashCopy™ (IBM), ShadowImage™ (Hitachi Data Systems and Hewlett Packard) or TimeFinder™ (EMC). In the description below, the generic name adopted for creating a tertiary data image is “Fast Internal Copy” or FIC. The creation of the tertiary data image ensures that failover capability is maintained. In present computer systems, resynchronisation may take many hours. However, the longer the whole resynchronisation process takes, the less valuable the tertiary data image becomes. Companies using computer systems with data mirroring, such as banking facilities, very often have a target defining how far the secondary devices may be behind on the primaries. The target is typically expressed in seconds or tens of seconds instead of in hours.

### SHORT DESCRIPTION

It is an object of the invention to provide a system and a method for primary to secondary resynchronisation that is faster and more efficient than in present methods.

Therefore, according to an aspect of the claimed invention, there is provided a method of data resynchronisation on a computer system arranged to store a plurality of primary logical volumes and a plurality of associated secondary logical volumes, the method comprising the execution of at least one copy thread and at least one resynchronisation thread in parallel, the copy thread being arranged to copy one of the secondary logical volumes to an associated tertiary logical volume at a time, the resynchronisation thread being arranged to resynchronise the one of the secondary logical volumes to an associated primary logical volume, wherein the one of the secondary logical volumes is resynchronised after completion of copying the one of the secondary logical volumes.

The secondary logical volumes may be organized in a plurality of volume groups, wherein K copy threads per volume group are executed, K being an integer less than a total number of secondary logical volumes per volume group.

In an embodiment, each of the plurality of volume groups comprises all secondary logical volumes stored on one or more, but not all, Redundant Arrays of Independent Disks (RAIDs). This grouping allows for the implementation of a resynchronisation control module that can effectively optimise the physical disk activity resulting from copying the secondary volumes to a tertiary image and the resynchronisation of the secondary volumes with the primary volumes.

In another embodiment, after completion of copying the one of the secondary logical volumes, an index number is entered into a list comprising index numbers of volumes to be resynchronised, and wherein the at least one resynchronisation thread starts resynchronising a next secondary logical volume after completion of a previous resynchronised secondary logical volume, wherein an index of the next secondary logical volume is read from the list.

According to another aspect of the invention, there is provided a method of data mirroring comprising mirroring of a plurality of primary logical volumes to a plurality of associated secondary logical volumes, wherein during the mirroring of the plurality of primary logical volumes, within each of the plurality of volume groups, a cyclic copying of the secondary volumes to associated tertiary volumes is performed wherein at one time M of the secondary logical volumes are copied to the associated tertiary logical volumes, M being an integer less than the total number of secondary logical volumes per volume group.

The invention also relates to a computer system according to claim 7, and according to claim 9.

### SHORT DESCRIPTION OF THE DRAWINGS

Embodiments of the invention will now be described, by way of example only, with reference to the accompanying schematic drawings in which corresponding reference symbols indicate corresponding parts, and in which:

FIG. 1 shows an example of a computer system according to the state of the art;

FIG. 2 shows an example of a secondary disk subsystem with secondary and tertiary logical volumes that represent a secondary and a tertiary data image;

FIG. 3 schematically shows part of a disk subsystem comprising a cluster with a cache and a non-volatile storage according to the state of the art;

FIG. 4 shows an example of a RAID comprising eight physical disks which store four secondary logical volumes;

FIG. 5 is a graph showing the number of writes to a SDSS together with the number of Fast Write Bypasses while resynchronisation takes place;

FIG. 6 shows a primary and a secondary disk subsystem with two control modules; one to control the cyclic execution of Incremental Fast Internal Copy on the secondary devices and one to control the resynchronisation of the primary with the secondary volumes;

FIG. 7 diagrammatically shows an example of a number of copy threads and resynchronisation threads together with two volume index lists;

FIG. 8 shows an example of a number of threads performing copy and resynchronisation tasks as a function of time, and

FIG. 9 is an example of cyclic copying of the logical volumes of a secondary RAID to logical volumes of a tertiary RAID.

### DETAILED DESCRIPTION

FIG. 1 shows an example of a computer system 1 according to the state of the art. The computer system 1 comprises a computer 2 in communication with a plurality of terminals 4, 5, 6 which may for example be personal computers or network computers. The computer system 1 further comprises a primary disk-subsystem (PDSS) 8 and a secondary disk subsystem (SDSS) 10 as will be known to the skilled person. FIG. 1 depicts a plurality of primary logical volumes 20, 21, 22, 23 stored on the PDSS 8. The primary logical volumes 20, 21, 22, 23 are mirrored, in a mirroring session, to their associated secondary logical volumes 20′, 21′, 22′, 23′ stored in SDSS 10.

If the mirroring session gets suspended, due to for example a disconnection of a communication line 25 from the PDSS 8 to the SDSS 10, the secondary logical volumes 20′, 21′, 22′, 23′ need to be re-synchronised once the connection is re-established. Resynchronisation may be done based on so-called bitmaps maintained in the PDSS 8. One bitmap is maintained for each primary logical volume 20, 21, 22, 23, such that it reflects which tracks on the logical volume were updated while in suspended mode. During re-synchronisation, indicated by an arrow in FIG. 1, the tracks of the primary logical volumes 20, 21, 22, 23 as recorded in the corresponding bitmaps need to be copied to their associated secondary logical volumes tracks.

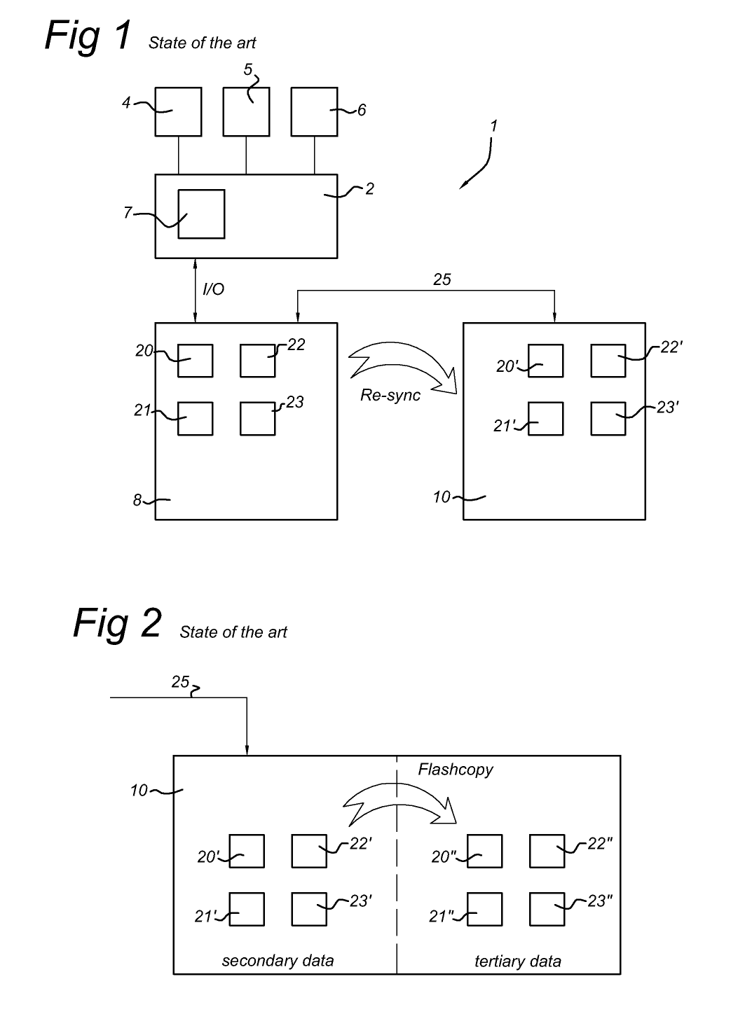

During resynchronisation, the collection of secondary logical volumes 20′, 21′, 22′, 23′ will not be in a consistent state, and therefore disaster fallback capability will not exist while resynchronisation proceeds. So to preserve failover capability, before the secondary logical volumes 20′, 21′, 22′, 23′ are resynchronised, they are copied to what is called a tertiary data image. For this copying, Fast Internal Copy may be used to create an instant image of the secondary data image. In FIG. 2, logical volumes 20″, 21″, 22″, 23″ of the tertiary data image are shown. In this example, the tertiary data image is stored on the SDSS 10.

Fast Internal Copy is a technology that allows a disk subsystem to create a near instantaneous mirror image of a logical volume. What is created is indeed an “image”: the copy of the logical volume is represented by a set of pointers that link to the original logical volume. The original logical volume, the source, and its image, the target, are available for read and write activity as soon as the pointer system has been initialised, which takes only a fraction of the time it takes to physically copy source to target,

In the example of FIG. 2, Fast Internal Copy is used to copy the secondary logical volumes 20′ to the tertiary logical volumes 20″. When updates occur on either the secondary or the tertiary logical volume, a track image (i.e. a track on the logical volume) on which the update must take place is first physically copied from the secondary logical volume to the tertiary logical volume 20″, 21″, 22″, 23″. This copying activity is referred to as an On-demand Copy (ODC).

Fast Internal Copy can be invoked with two options: Copy or Nocopy. With the Copy option the SDSS 10 will make a full copy of the secondary logical volume 20′ to the tertiary logical volume 20″ while normal application I/O to secondary volume 20′ continues. Therefore this copying is also referred to as Background Copy. An ODC can occur only while the Background Copy proceeds, but not any more once the Background Copy is completed.

With Nocopy the disk subsystem does not make a full volume copy, but On-demand Copies will be done when prompted by Source (volume 20′) or Target (volume 20″) updates.

Another basic technology that is already available on the market is Incremental Fast Internal Copy (IFIC). IFIC copies data from a Source to a Target and maintains a bitmap of tracks changed since the time of invocation. So when the next IFIC is initiated, it needs to copy just the tracks that were changed since the previous invocation.

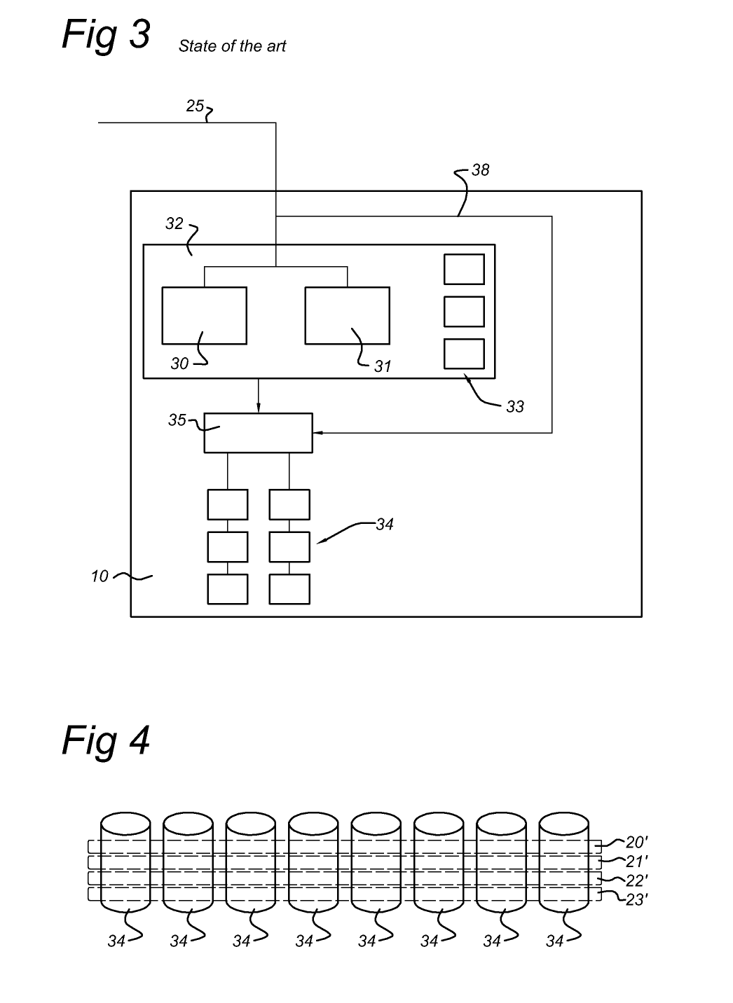

FIG. 3 schematically shows part of the SDSS 10 that comprises a cluster 32 with a cache 30 and a non-volatile storage (NVS) 31 according to the state of the art. The cluster 32 further comprises a plurality of processors 33. The cluster 32 is arranged to communicate with the PDSS 8 as shown in FIG. 1. The cluster 32 receives and processes data coming from the communication line 25 and stores the data into physical discs 34, see FIG. 3. The cluster 32 communicates with a device adapter 35 that directly communicates with the physical discs 34. The device adapter 35 is arranged to map logical volumes on the physical volumes (i.e. disks), so the cluster 32 will only experience logical volumes instead of the physical volumes 34. The physical discs 34 may be grouped into Redundant Arrays of Independent Disks (RAID) to increase redundancy. FIG. 4 shows an example of a RAID comprising eight physical disks 34 which store four of the secondary logical volumes 20′, 21′, 22′, 23′. A set of one or more RAIDs is referred to as a group. The PDSS 8 and the SDSS 10 may each comprise one or more groups.

When one of the secondary logical volumes 20′, 21′, 22′, 23′ receives an update while it is in a Fast Internal Copy relationship with one of the tertiary logical volumes 20″, 21″, 22″, 23″, the execution of that update is not delayed: the update is committed to the cache 30 and the NVS 31 and then the update is complete. However, by the time this update gets destaged (i.e. copied) to the physical discs 34, an ODC takes place and the destage will be delayed until the ODC is completed. As a consequence, the ODC interferes with the destage algorithm in SDSS 10 and in effect reduces its efficiency. This is not something to be worried about when the update frequency is low, but it can significantly decrease the performance of the SDSS 10 when the update frequency is high. In that case, the impaired destaging capability results in the NVS 31 getting full. Once the NVS 31 is full, next writes to the SDSS 10 may only be processed using algorithms such as the so-called Fast Write Bypass algorithm. The Fast Write Bypass algorithm is designed to handle an NVS full condition by sending updates directly to the device adapter 35 to be handled in real-time with the physical discs 34. The Fast Write Bypass algorithm is substantially slower than the normal write procedure (hundreds versus less than 10 milliseconds), and therefore considerably decreases the performance of the SDSS 10.

When resynchronisation is needed, at present, a user typically uses a single interaction to request resynchronisation for all the logical volumes 20, 21, 22, 23 at once. For example, in Extended Remote Copy the command will be: XADDPAIR SUSPENDED. There exists a function, implemented in either software or in firmware (i.e. micro code on the PDSS 8), that attempts to optimise the copy process. The purpose of that function is to make sure that host I/O (i.e. I/O communication between the computer 2 and the PDSS 8) takes priority over resynchronisation activity and to prevent internal resources of the PDSS 8 from being overcommitted. The last is achieved by limiting parallelism: only a certain number of logical volumes 20, 21, 22, 23 will be resynchronised in parallel. However, within the limits described above, the resynchronisation process will run as fast as it can go and does therefore create an intensive, write-only load on the SDSS 10. When resynchronisation starts, each logical track being transmitted from the PDSS 8 to the SDSS 10 will cause an ODC in the SDSS 10 when using the Nocopy option of Fast Internal Copy. When using the Copy option of Fast Internal Copy, there will be an intensive ODC-activity in the beginning, which then gradually diminishes. However, when using the Fast Internal Copy Copy option, there is a substantial amount of work involved for the physical discs 34 because all tracks of a logical volume must be read from the physical disks 34 where the secondary volumes 20′, 21′, 22′, 23′ are and written to other physical discs (not shown) where the tertiary volumes 20″, 21″, 22″, 23″ are.

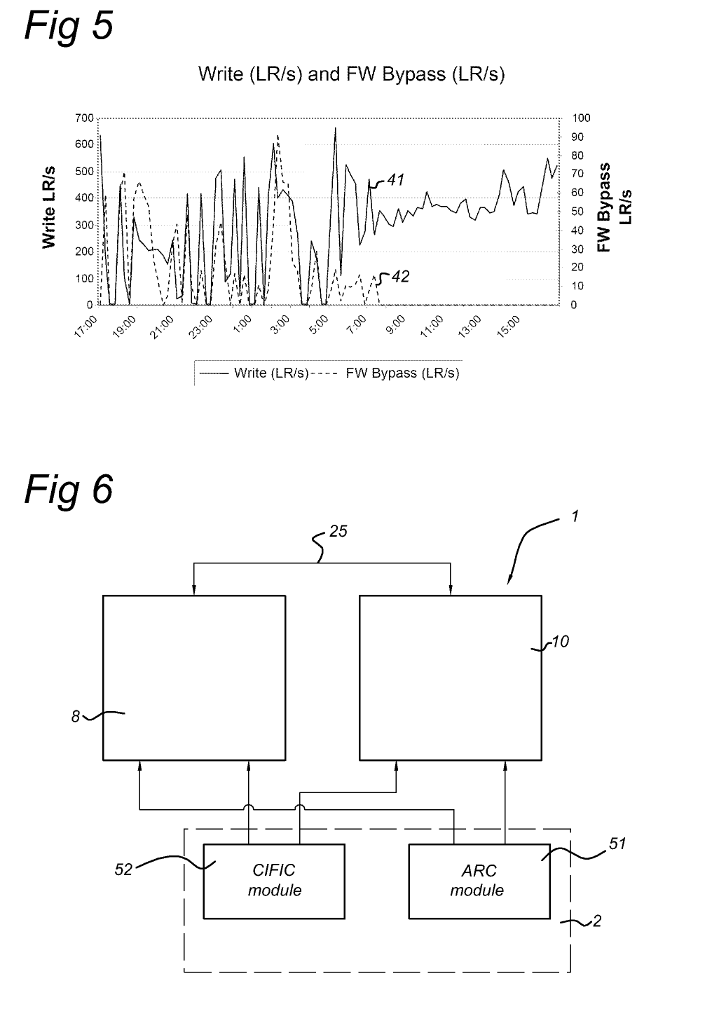

In either case there is a serious risk that destaging is impaired to the extent that the NVS 31 becomes full and writes have to be done in Fast Write Bypass mode. When this happens, the SDSS 10 will become considerably slower than the PDSS 8, even if it has the same resources (i.e. same make and model, same physical disks). An example of what may happen once the NVS 31 becomes full is illustrated with reference to FIG. 5. FIG. 5 is based on data taken from an installation that is in a process of resynchronising the logical volumes. Line 41 represents the number of writes to the SDSS 8 and line 42 represents the number of Fast Write Bypasses.

The chart shown in FIG. 5 represents activity in a real SDSS while resynchronisation takes place. As can be seen, resynchronisation is started at 5:00 pm one day and is finished at around 7:30 am the next day. This means that the most recent fallback data ages by 14.5 hours due to resynchronisation alone. To be added to that is the time the data mirroring session was in suspended mode. During resynchronisation there are many Fast Write Bypasses (line 42) with a disastrous effect on the time it takes to complete the resynchronisation. When resynchronisation has been completed, the Fast Write Bypasses disappear and the write activity stabilizes. Note that the fact that Fast Write Bypasses are occurring is hard evidence that the NVS 31 is full. Installations that implement data mirroring aim for a Recovery Point Objective (RPO) that is measured in seconds or some tens of seconds. An RPO that runs into minutes or even hours, as shown in FIG. 5, is unacceptable for commercial organisations.

According to an embodiment of the invention, the computer system 1 as described above comprises a new control module 51 also referred to as Advanced Resynchronisation Control (ARC) module 51, see FIG. 6. The ARC module 51 is arranged to execute at least one copy thread and at least one resynchronisation thread in parallel. The copy thread is arranged to copy one of the secondary logical volumes to an associated tertiary logical volume at a time. The resynchronisation thread is arranged to resynchronise the one secondary logical volume to an associated primary logical volume. The ARC module 51 coordinates the copy and resynchronization threads such that the background copy of a secondary volume completes before its resynchronization is started.

The ARC module 51 is arranged to coordinate the sending of copy requests to the secondary disk subsystem 10 and the sending of resynchronisation requests to the primary disk subsystem 8. The ARC module 51 may be arranged as an automation solution in the computer 2, for instance integrating with a so-called Geographically Dispersed Parallel Sysplex. The ARC module 51 may instead be arranged in the primary disk subsystem 8. However, this would require each manufacturer to implement the ARC module 51, in a consistent fashion, something that will be more difficult to achieve.

The embodiment with the ARC module 51 implements a procedure that serializes Fast Internal Copy and resynchronisation at the volume level, i.e. a Fast Internal Copy of a specific secondary volume is executed before starting its resynchronisation.

Currently, a primary disk subsystem manages the degree of parallelism in resynchronisation and a secondary disk subsystem manages the degree in parallelism in executing the Fast Internal Copy, but the two do not coordinate their actions, thereby missing an opportunity to be more effective than they are today. By coordinating the two processes as described above, the invention makes resynchronisation more efficient.

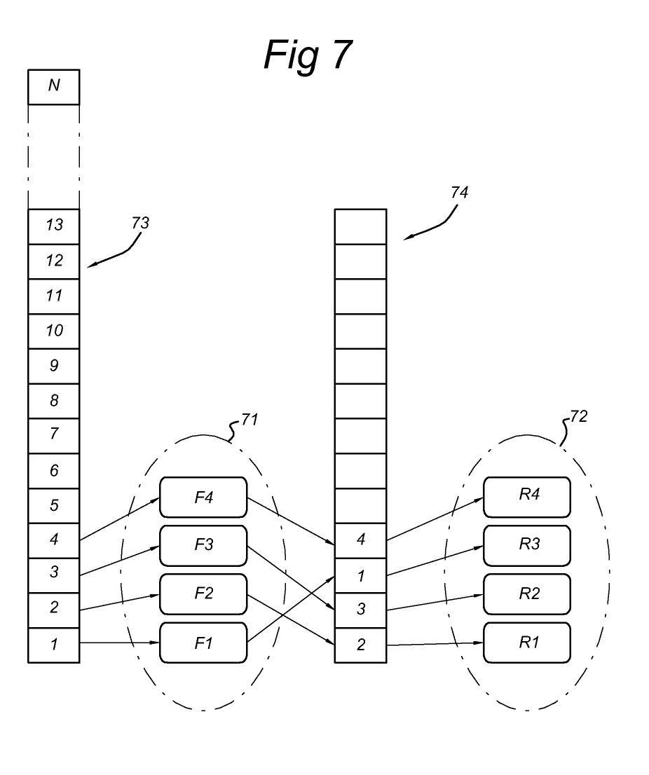

The invention will now be explained in more detail by way of a specific example with reference to FIG. 7. FIG. 7 diagrammatically shows a number of copy threads 71 and resynchronisation threads 72 together with two volume index lists 73, 74. List 73 comprises an index of all logical secondary volumes 20′, 21′, 22′, 23′ stored on one specific RAID. The index numbers range from 1-N where N is the total number of logical volumes stores on the RAID. The copy threads are named F1-F4. Each of the copy threads F1-F4 is arranged to copy a secondary logical volume to an associated tertiary logical volume, using Fast Internal Copy. When a secondary logical volume is copied to its associated tertiary logical volume, an index of the logical volume is added to a list 74 comprising the indexes of copied logical volumes to be synchronised. The list 74 is input for the resynchronisation threads. If a synchronisation thread 72 is idle, it will look at the list 74 to see which next logical volume needs to be resynchronised.

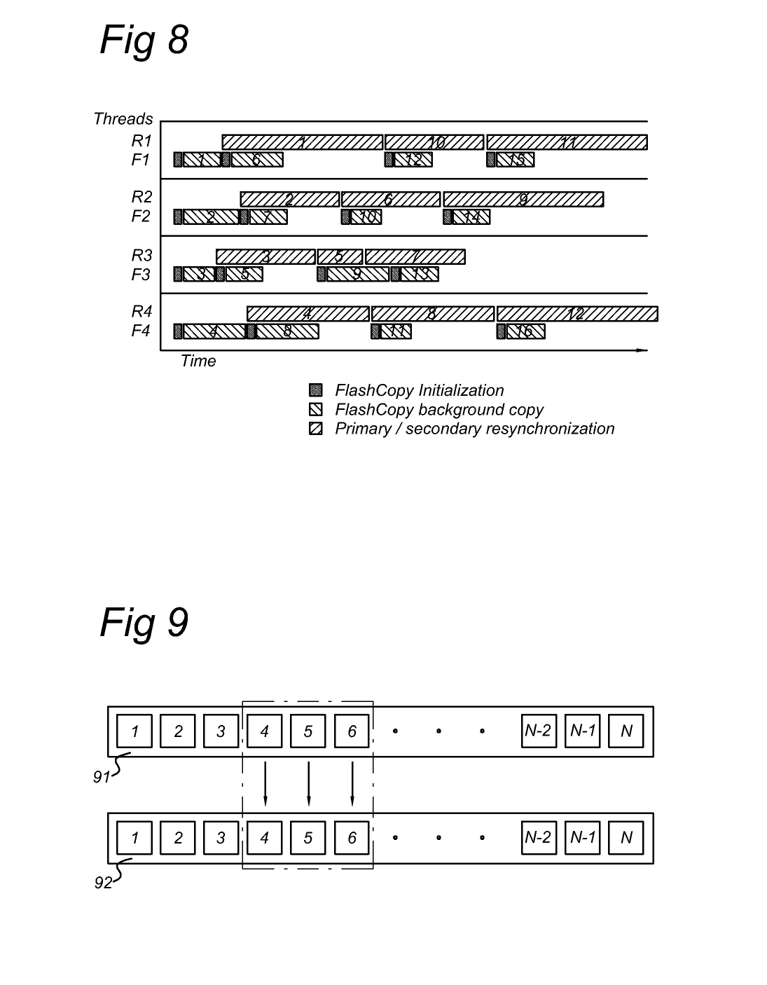

An important aspect of the ARC module 51 is that Fast Internal Copy and resynchronisation are serialized on a volume pair basis. Contrary to what usually happens today, which is a Fast Internal Copy request for all secondary logical volumes followed by a resynchronisation request for all primary logical volumes, the ARC module 51 requests a Fast Internal Copy for a limited number of secondary volumes in each group, waits for Fast Internal Copy completion of each individual secondary volume and then issues a resynchronisation request to the matching primary logical volume. This results in a staggered resynchronisation, as illustrated in FIG. 8. FIG. 8 shows an example of a Fast Internal Copy /resynchronisation process as it takes place within a single RAID according to an embodiment. FIG. 8 shows four Fast Internal Copy threads, F1, F2, F3 and F4, which share the first list 73 of volumes to be copied and an additional four Resynchronization threads 72 that share the second list 74 of volumes to be resynchronized. When the Fast Internal Copy for a volume is completed, its index is added to the second list 74. A next available thread will read the second list 74, and will start resynchronising the volume that is on top of the second common list.

In an embodiment, the ARC module 51 allows for a user-initiated change in the number of Copy and Resynchronisation threads per group, such that the throughput of the process can be optimized for a specific installation. Note that there are many factors that could have an influence on determining the optimum number of threads, such as the physical disk's revolution speed, the way a disk subsystem implements Fast Internal Copy and the way the secondary and tertiary logical volumes are associated with RAID structures. Some logical volumes will resynchronise very quickly (because there were no or hardly any updates), in which case the copy thread that was started at the same time might take more time. In the example of FIG. 8, the resynchronisation of volume 5 performed by resynchronisation thread R3 completes faster than the copy thread F3 copying logical volume 9. In this case, resynchronisation thread R3 continues with the resynchronisation of the next available volume in the second list 74, which is volume 7. In the example, the number K of threads to be processed in parallel is arbitrarily set to 4. Other values are possible. The value for K may be determined dynamically during execution of the copy/resync process using for example information on available resources.

It may seem strange that a series of Fast Internal Copy requests that are issued at random moments in time can be used to create a time-consistent tertiary data image, but since the secondary devices are suspended, they are not being updated and therefore the only dependency is to issue the Fast Internal Copy request for an individual secondary volume before issuing the resynchronisation request for that volume.

It should be noted that Fast Internal Copy requests must be sent to the secondary disk subsystem 10 and resynchronisation requests to the primary disk subsystem 8. So communication to both disk subsystems 8, 10 will be required. This impacts where the ARC module 51 could be run: in software or in firmware. In XRC there is no direct communication path between primary and secondary disk subsystem, precluding disk subsystem to disk subsystem coordination, so a firmware implementation in PDSS 8 or in SDSS 10 is not feasible. In a synchronous data mirroring configuration, there is a direct communication path between primary and secondary disk subsystem, so a firmware implementation is possible.

As already mentioned above, the most suitable place to build the new ARC module 51 would be GDPS since it already maintains essential information about the data mirroring configuration and because the ARC module 51 lends itself well to being implemented as an automation solution. The coordination of Fast Internal Copy and resynchronisation is relatively easy to do, in the sense that the commands are already available and thus it is a matter of issuing them in the proper order, per volume pair.

Ideally the secondary logical to physical volume mapping should be the most decisive factor in determining which volume pairs can be synchronized at the same time since the secondary disk subsystem potentially has more work to do than the primary. For instance, when not all volumes in the primary location are mirrored, it could be that a single secondary RAID has to cope with (most of) the write activity of multiple primary RAIDs.

In an embodiment, the ARC module 51 uses CQUERY or XQUERY CONFIGURATION commands to obtain information about the association of primary or secondary volumes within each of the groups. This allows the ARC 51 to manage the Fast Internal Copy and resynchronisation parallelism by group. This level of control makes it possible to generate an equal amount of work across all the groups, without over-stressing the physical disks in any of the groups.

If the ARC module 51 is implemented in firmware (i.e. micro code on one of the disk subsystems 8, 10), the ARC module 51 can take advantage of the fact that in for example a synchronous data mirroring configuration, the primary disk subsystem 8 has information about where each secondary disk in subsystem 10 is that belongs to each of its primary devices. So with a direct subsystem to subsystem connection being available, it could issue Fast Internal Copy commands to the correct disk subsystem and secondary device. Resynchronisation may be initiated as today, by issuing a command/commands to the primary disk subsystem 8, but it would require one new parameter: TCopy (for Tertitary Copy). For instance: CESTPAIR MODE(RESYNC,TCOPY). The TCOPY parameter will trigger the primary disk subsystem 8 to manage the resynchronisation according to specific rules described in the ARC module 51. The additional protocol requirement will be a “Prepare for Resynchronisation” command to the secondary disk subsystem 10 for a particular volume, which prompts the secondary disk subsystem 10 to initiate an Incremental Fast Internal Copy for the specified volume. When the Fast Internal Copy is complete, the SDSS 10 responds with “Preparation Complete”, which will then allow the PDSS 8 to start resynchronisation for the volume pair.

Anticipating that there will always be a next occasion where the secondary image needs to be copied to the tertiary image before resynchronising primary and secondary volumes, according to an embodiment, a permanently active copying procedure is set up that reduces the amount of time needed to copy the secondary image to the tertiary image prior to resynchronisation. The copying procedure is performed during mirroring of the data images, but it may proceed once the computer system 1 is in suspended mode.

FIG. 6 shows part of an embodiment of the invention, in which a computer system 1 comprises primary disk subsystem 8, secondary disk subsystem 10, and a Cyclic Incremental Fast Internal Copy (CIFIC) control module 52, also referred to as CIFIC module 52. The primary disk subsystem 8 is arranged to store a plurality of primary logical volumes 20, 21, 22, 23 as shown in FIG. 1, and the secondary disk subsystem 10 is arranged to store a plurality of secondary logical volumes 20′, 21′, 22′, 23′. The control module 52 is arranged to communicate with the secondary disk subsystem 10. According to a specific embodiment, a cyclic copying of secondary volumes to associated tertiary volumes is performed. Within a group, M of the secondary logical volumes 20′, 21′, 22′, 23′are copied to their associated tertiary logical volumes 20″, 21″, 22″, 23″, wherein M is less than a total number of secondary logical volumes in a volume group.

According to an embodiment, the secondary volumes 20′, 21′, 22′, 23′ are copied to their associated tertiary volumes 20″, 21″, 22″, 23″ in a cyclic procedure using CIFIC in which CIFIC is active all the time during normal a mirroring session. Only a limited number M of volumes per volume group is copied at the same time.

The CIFIC may be executed per RAID. FIG. 9 shows an example wherein only three (i.e. M=3) logical volumes of a secondary RAID 91 are copied at the same time to logical volumes of a tertiary RAID 92. When the last three logical volumes of the secondary RAID 91 (i.e. volume ‘N−2’, ‘N−1’ and ‘N’) are copied, the copying starts again with the first three logical volumes.

The CIFIC is controlled by the control module 52 such that the disk subsystem activity associated with the copying does not interfere with the regular I/O activity on the secondary disk subsystem 10.

A RAID may for example comprise 120 logical volumes (i.e. N=120) and a group may comprise for example 2 RAIDs.

The secondary volumes remain in Duplex status (i.e. they will be updated on every update event of the primary volumes) while in the background they are incrementally copied. There may be On-demand Copy activity, but its effect on the performance is limited because there are a small number of volumes being incrementally copied at the same time.

The control module 52 which is arranged to control the CIFIC copying, could be arranged in software loaded on a computer that has access to SDSS 10, such as the Geographically Dispersed Parallel Sysplex™ (GDPS™) module 7, see FIG. 1. GDPS exists in a form that manages synchronous Peer-to-Peer Remote Copy (GDPS/PPRC) and another one that manages asynchronous XRC (GDPS/XRC), so it is preferred to implement the CIFIC module52 in the GDPS module 7.

Alternatively, the CIFIC module 52 could be implemented in SDSS 10 firmware. The main attraction would be the external simplicity of this solution: there would be a minimal amount of new controls that an installation would have to know and worry about. In an embodiment, an additional “cycle” parameter in the Fast Internal Copy command is implemented, so that a copy command may look like:

### FCESTABL . . . INCREMENTAL(YES,CYCLE)

In this embodiment, the CYCLE parameter instructs SDSS 10 to keep executing successive Fast Internal Copies until there is a command that terminates the Incremental Fast Internal Copy relationship or until the arrival of an incremental Fast Internal Copy request without the CYCLE parameter.

The result of Cyclic Incremental Fast Internal Copy (CIFIC) is that whenever the remote copy session breaks, the secondary and tertiary volumes are nearly identical, with a minimal amount of data to copy for an incremental Fast Internal Copy. In addition, since the secondary image, which is the PPRC or XRC secondary image, is no longer updated while in suspended mode, while CIFIC continues to run, the secondary volumes 20′, 21′, 22′, 23′ and the tertiary volumes 20″, 21″, 22″, 23″ might well be the same by the time resynchronisation of the primary volumes 20, 21, 22, 23 and secondary volumes 20′, 21′, 22′, 23′ is initiated.

Note that CIFIC would never create a consistent tertiary image on the tertiary volumes, but that is not a requirement. The tertiary image needs to be made consistent only before initiating primary/secondary resynchronisation.

Control module 51 provides a procedure to make resynchronisation of suspended data mirroring pairs (i.e. volumes) more efficient. By implementing an additional control module 52 that keeps the Fast Internal Copy Target content (i.e. the tertiary volumes) as close to the Source (i.e. the secondary volumes) as possible, the computer system is always prepared for resynchronisation. It should be noted that the control module 52 may also be used without the control module 51. In this case, only the cyclic copying is performed.

While specific embodiments of the invention have been described above, it will be appreciated that the invention may be practiced otherwise than as described. For example, the invention may take the form of a computer program containing one or more sequences of machine-readable instructions implementing a method as disclosed above, or a data storage medium (e.g. semiconductor memory, magnetic or optical disk) having such a computer program stored therein. It will be understood by a skilled person that all software components may also be formed as hardware components.

The descriptions above are intended to be illustrative, not limiting. Thus, it will be apparent to one skilled in the art that modifications may be made to the invention as described without departing from the scope of the claims set out below.

1. A method of data resynchronisation on a computer system arranged to store a plurality of primary logical volumes and a plurality of associated secondary logical volumes, said method comprising the execution of at least one copy thread and at least one resynchronisation thread in parallel, said copy thread being arranged to copy one of said secondary logical volumes to an associated tertiary logical volume at a time, and said resynchronisation thread being arranged to resynchronise said one of said secondary logical volumes to an associated primary logical volume, wherein resynchronisation of said one of said secondary logical volumes starts after completion of copying said one of said secondary logical volumes.

2. The method according to claim 1, wherein said secondary logical volumes are organized in a plurality of volume groups, wherein K copy threads per volume group are executed, K being an integer less than a total number of secondary logical volumes per volume group.

3. The method according to claim 2, wherein each of said plurality of volume groups comprises all secondary logical volumes stored on one or more Redundant Arrays of Independent Disks (RAIDs).

4. The method according to claim 1, wherein after completion of copying said one of said secondary logical volumes, an index number is entered into a list comprising index numbers of volumes to be resynchronised, wherein said at least one resynchronisation thread starts resynchronising a next secondary logical volume after completion of a previous resynchronised secondary logical volume, wherein an index of said next secondary logical volume is read from said list.

5. A method of data mirroring comprising mirroring of a plurality of primary logical volumes to a plurality of associated secondary logical volumes, said secondary logical volumes being organized in a plurality of volume groups, wherein during said mirroring of said plurality of primary logical volumes, within each of said plurality of volume groups, a cyclic copying of said secondary volumes to associated tertiary volumes is performed wherein at one time M of said secondary logical volumes are copied to said associated tertiary logical volumes, M being an integer less than said total number of secondary logical volumes per volume group.

6. The method according to claim 5, wherein said cyclic copying is performed using FlashCopy™, ShadowImage™ or TimeFinder™.

7. A computer system comprising a primary disk subsystem, a secondary disk subsystem, and a control module, wherein said primary disk subsystem arranged to store a plurality of primary volumes and said secondary disk subsystem is arranged to store a plurality of secondary volumes, said primary and said secondary disk subsystem being arranged to mirror said plurality of primary logical volumes to said plurality of secondary logical volumes, wherein said control module arranged to execute at least one copy thread and at least one resynchronisation thread in parallel, said copy thread being arranged to copy one of said secondary logical volumes to an associated tertiary logical volume at a time, and said resynchronisation thread being arranged to resynchronise said one of said secondary logical volumes to an associated primary logical volume, and wherein said one of said secondary logical volumes is resynchronised after completion of copying said one of said secondary logical volumes.

8. The computer system according to claim 7, wherein said secondary logical volumes are organized in a plurality of volume groups, wherein K copy threads per volume group are executed, K being an integer less than a total number of secondary logical volumes per volume group.

9. A computer system comprising a primary disk subsystem, a secondary disk subsystem, and a control module, wherein said primary disk subsystem is arranged to store a plurality of primary volumes and said secondary disk subsystem is arranged to store a plurality of secondary volumes, said primary and said secondary disk subsystem being arranged to mirror said plurality of primary logical volumes to said plurality of secondary logical volumes wherein said secondary logical volumes are organized in a plurality of volume groups, wherein said control module is arranged to perform, during said mirroring of said plurality of primary logical volumes, within each of said plurality of volume groups, a cyclic copying of said secondary volumes to associated tertiary volumes, and wherein at one time M of said secondary logical volumes are copied to said associated tertiary logical volumes, M being an integer less than a total number of secondary logical volumes per volume group.
